(19) United States
(12) Patent Application Publication
(10) Pub. No.: US 2009/0229167 A1
(43) Pub. Date: Sep. 17, 2009

(54) METHOD AND APPARATUS FOR DEHOOKING FISH WITH LINE LATCH

(76) Inventor: David N. Doss, Gulfport, FL (US)

Correspondence Address: LARSON AND LARSON, 11199 69TH STREET NORTH, LARGO, FL, 33773, US

(21) Appl. No.: 12/047,966

(22) Filed: Mar. 13, 2008

(51) Int. Cl. A01K 97/18

(52) U.S. Cl. 43/53.5

(57) ABSTRACT

An application for a fish dehooker with a line latch includes a shaft with a handle at its first end. A partial loop is affixed at a distal end of the shaft and has an open section. A spring-loaded gate is pivotally affixed to the partial loop thereby covering the open section. The spring-loaded gate opens inward within the partial loop when pressed by a fishing line and closes after the fishing line passes, holding the fishing line within the partial loop.

### FIELD OF THE INVENTION

This invention relates to the field of fishing and more particularly to a method and apparatus for removing a fish hook from a fish.

### BACKGROUND OF THE INVENTION

There are many circumstances where a fisherman catches a fish and returns it to the wild. One circumstance is “catch and release,” in that the fish is caught purely for the sport of catching the fish and there is never any intention of keeping the fish. Another is when a fish is caught and it is not legal to keep such as in deep sea fishing when the fish is to short or there is a ban on that species of fish.

Often the fish hook is removed (dehooked) using a pair of pliers. This method requires the fish to be lifted out of the water and held while the pliers are used to pry the hook out of the fish's mouth. This method puts extra stress on the fish and often tears more tissue than need be to remove the hook.

Many dehooking devices are known in the industry. For example, a fish dehooking device is described in U.S. Pat. No. 4,914,853 to Swindle. This fish dehooker has a handle, an elongated rod and a hooked or looping end. The idea is to loop the hook or looping end around the fishing line and follow it down to the fish's mouth or throat the apply pressure on the handle/shaft while pulling on the fishing line. Although this device works under some conditions, it is often very difficult to keep the line in the hooked or looped end while fighting the fish, wind and waves.

Another such device is described in U.S. Pat. No. 6,840,002 to Dick. The described dehooker is similar to that in U.S. Pat. No. 4,914,853 with the addition of a slidable bite sleeve over the elongated rod. Even with this additional feature, it is still very difficult to keep the line in the hooked or looped end while fighting the fish, wind and waves.

Again, a fish dehooker is described in U.S. Pat. No. 3,019,547 to Felts. This dehooker is similar to the above devices but has a narrow slot through which the fishing line is passed before following the fishing line to the hook for removal. Likewise, it is difficult to keep the line in the hooked or looped end while fighting the fish, wind and waves.

What is needed is fish dehooker that positively locks onto the fishing line while following the fishing line down to the hook for removal of the hook.

### SUMMARY OF THE INVENTION

In one embodiment, a fish dehooker with a line latch is disclosed including a shaft with a handle at its first end. A partial loop is affixed at a distal end of the shaft and has an open section. A spring-loaded gate is pivotally affixed to the partial loop thereby covering the open section. The spring-loaded gate opens inward within the partial loop when pressed by a fishing line and closes after the fishing line passes, holding the fishing line within the partial loop.

In another embodiment, a method of dehooking marine wildlife is disclosed including providing a fish caught on a hook, the hook being attached to a fishing line. A fish dehooker is provided and includes a shaft with a handle at its first end. A partial loop is mounted at a distal end of the shaft and has an open section. A spring-loaded gate is pivotally affixed to the partial loop thereby covering the open section. The spring-loaded gate opens inward within the partial loop when pressed by the fishing line and closes holding the fishing line within the partial loop. The method continues with applying pressure to the fishing line by the spring-loaded gate, thereby opening the spring loaded gate; the fishing line entering the partial loop. Next, the gate is closed behind the fishing line thereby capturing the fishing line within the partial loop and then the dehooker is held by the handle and the partial loop is guided down the line to the site of the hook. The fish is dislodged by thrusting on the handle while holding the fishing line.

In another embodiment, a fish dehooker with a line latch is disclosed including a shaft with a handle affixed at its first end. A partial loop is situated at a distal end of the shaft and has an open section. A device is provided for sealing the partial loop, and is pivotally affixed to the partial loop. The device opens in an inward direction within the partial loop in response to pressure of a fishing line and closes after the fishing line is within the partial loop and the pressure abates.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a system of a first embodiment of the present invention.

FIG. 2 illustrates a front perspective view of a first embodiment of the present invention.

FIG. 3 illustrates a top perspective view of the first embodiment of the present invention.

FIG. 4 illustrates a front perspective view of a second embodiment of the present invention.

FIG. 5 illustrates a top perspective view of the second embodiment of the present invention.

FIG. 6 illustrates a first perspective view of the first embodiment of the present invention in use.

FIG. 7 illustrates a continuation of the first perspective view of the first embodiment of the present invention in use.

FIG. 8 illustrates another continuation of the first perspective view of the first embodiment of the present invention in use.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

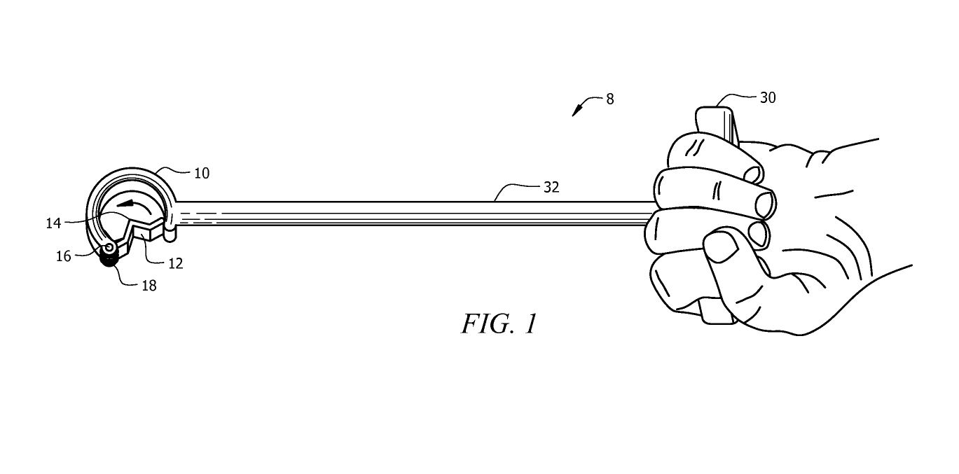

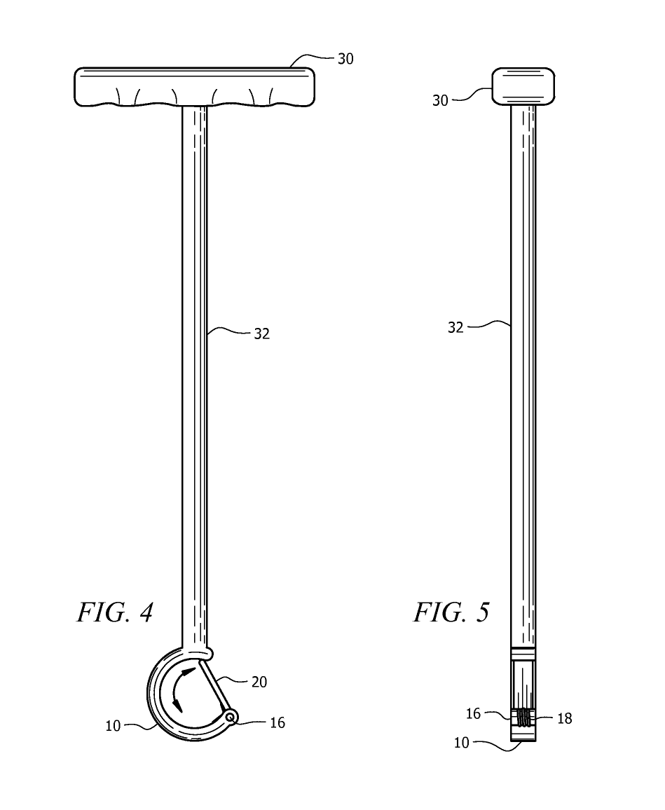

Referring to FIG. 1, a perspective view of a system of a first embodiment of the present invention is shown. The fish hook dehooker 8 includes a handle 30 and, at one end, an elongated shaft 32 for holding the fish hook dehooker 8 and extending into the fish's mouth/throat where the hook is lodged. At the other end of the shaft 32 is a partial loop 10. The partial loop 10 is the section of the fish hook dehooker 8 that engages with the fish to assist in dislodging the fishhook. The partial loop 10 has an open portion equipped with a gate or latch 12. The gate or latch 12 is hinged at one end to the partial loop 10 with a hinge pin 16, as known in the industry. The other end of the gate or latch 12 is held against the partial loop 10 by the force of the spring 18. In this embodiment, the spring 18 is a torsion spring. In other embodiments, other types of springs are included such as leaf springs as known in the art of carabineers. In some embodiments, the gate or latch 12 is flat (see FIG. 4). In some embodiments the gate or latch 12 is curved (not shown). In the embodiment of FIG. 1, the latch has a detent 14 to assist in positioning the fishing line during the process of capturing the line within the partial loop 10. In operation, the gate/latch 12 is pushed against the fishing line until the gate/latch 12 opens, at which time the fishing line passes into the partial loop 10. The gate/latch 12 closes after the fishing line enters the partial loop 10; holding the fishing line within the partial loop 10. The partial loop 10 end of the fish hook dehooker 8 is run down the fishing line to the fishing hook for assisting with the dehooking of the hook.

Although the handle 30 is shown as a T-shaped handle, any shape and/or size is anticipated without veering from the present invention. For example, a bicycle-type handle grip on the end of the shaft 30 functions perfectly without veering from the present invention.

Although the partial loop 10 is shown as a partial circle, any shape and/or size is anticipated without veering from the present invention. For example, an oval shape or an irregular shape functions without veering from the present invention.

Although the shaft 32 is shown as a straight shaft, any shape of shaft is anticipated including a shaft with a bend. Likewise, the cross-sectional shape of the shaft 32 is shown as circular whereas any cross-sectional shape is anticipated including square, rectangle, octagon, pentagon, etc.

The handle 30, shaft 32, partial loop 10 and gate/latch 12 are preferably made from a sturdy, stiff material such as steel, stainless steel, hard plastic and the like. In some embodiments, the handle 30 is coated or covered (as shown in FIG. 1) with a softer material to improve comfort.

Although this description uses a fish as an example, any type of wildlife is a candidate for dehooking using the present invention including, but not limited to, fish, stingray, marine mammals, reptiles and birds.

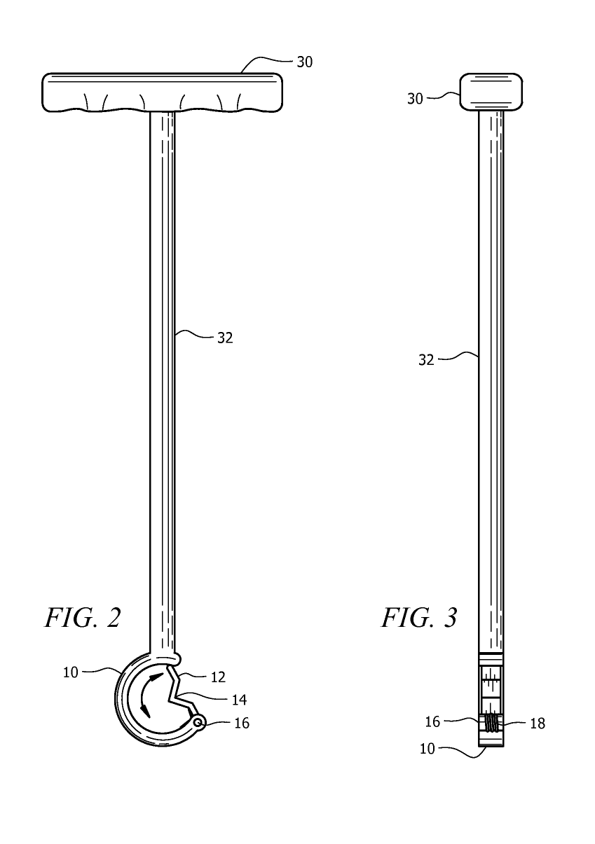

Referring to FIGS. 2 and 3 a front and top perspective view of a first embodiment of the present invention is shown. The fish hook dehooker 8 includes a handle 30 and, at one end, an elongated shaft 32 for holding the fish hook dehooker 8 and extending into the fish's mouth/throat where the hook is lodged. At the other end of the shaft 32 is a partial loop 10. The partial loop 10 is the section of the fish hook dehooker 8 that engages with the fish to assist in dislodging the fishhook. The partial loop 10 has an open portion equipped with a gate or latch 12. The gate or latch 12 is hinged at one end to the partial loop 10 with a hinge pin 16, as known in the industry. The other end of the gate or latch 12 is held against the partial loop 10 by the force of the spring 18. In this embodiment, the spring 18 is a torsion spring. In other embodiments, other types of springs are included such as leaf springs as known in the art of carabineers. In some embodiments, the gate or latch 12 is flat (see FIG. 4). In some embodiments the gate or latch 12 is curved (not shown). The latch has a detent 14 to assist in positioning the fishing line during the process of capturing the line within the partial loop 10. In operation, the gate/latch 12 is pushed against the fishing line until the gate/latch 12 opens, at which time the fishing line passes into the partial loop 10. The gate/latch 12 closes after the fishing line enters the partial loop 10; holding the fishing line within the partial loop 10. The partial loop 10 end of the fish hook dehooker 8 is run down the fishing line to the fishing hook for assisting with the dehooking of the hook.

Referring to FIGS. 4 and 5 a front perspective view of a second embodiment of the present invention is shown. The fish hook dehooker includes a handle 30 and, at one end, an elongated shaft 32 for holding the fish hook dehooker and extending into the fish's mouth/throat where the hook is lodged. At the other end of the shaft 32 is a partial loop 10. The partial loop 10 is the section of the fish hook dehooker that engages with the fish to assist in dislodging the fishhook. The partial loop 10 has an open portion equipped with a gate or latch 20. The gate or latch 20 is hinged at one end to the partial loop 10 with a hinge pin 16, as known in the industry. The other end of the gate or latch 20 is held against the partial loop 10 by the force of the spring 18. In this embodiment, the spring 18 is a torsion spring. In other embodiments, other types of springs are included such as leaf springs as known in the art of carabineers. In this embodiment, the gate or latch 20 is flat. In other embodiments the gate or latch is curved (not shown). In operation, the gate/latch 20 is pushed against the fishing line until the gate/latch 20 opens, at which time the fishing line passes into the partial loop 10. The gate/latch 20 closes after the fishing line enters the partial loop 10; holding the fishing line within the partial loop 10. The partial loop 10 end of the fish hook dehooker 8 is run down the fishing line to the fishing hook for assisting with the dehooking of the hook.

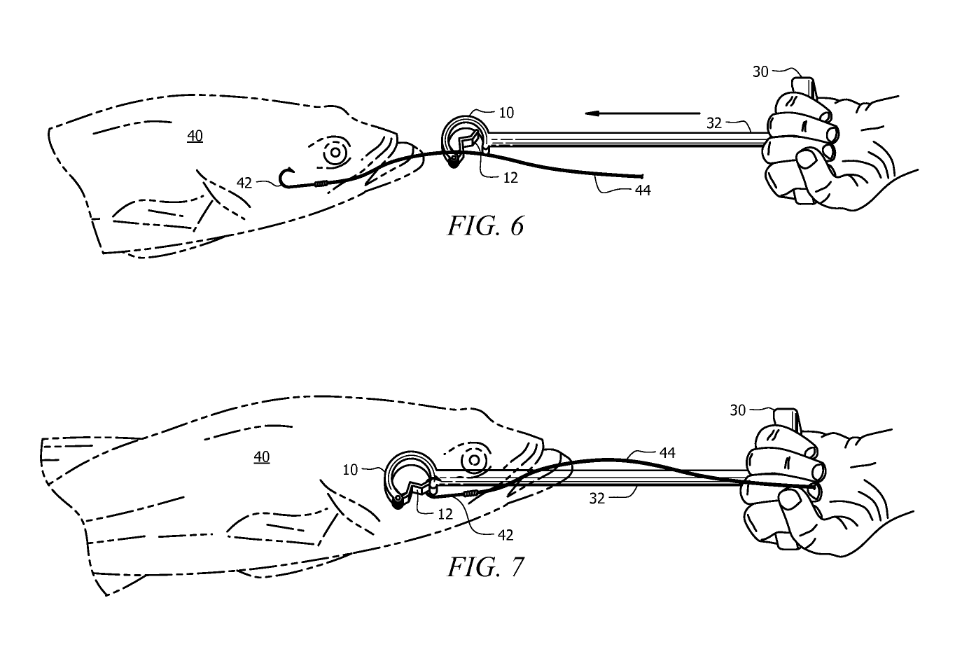

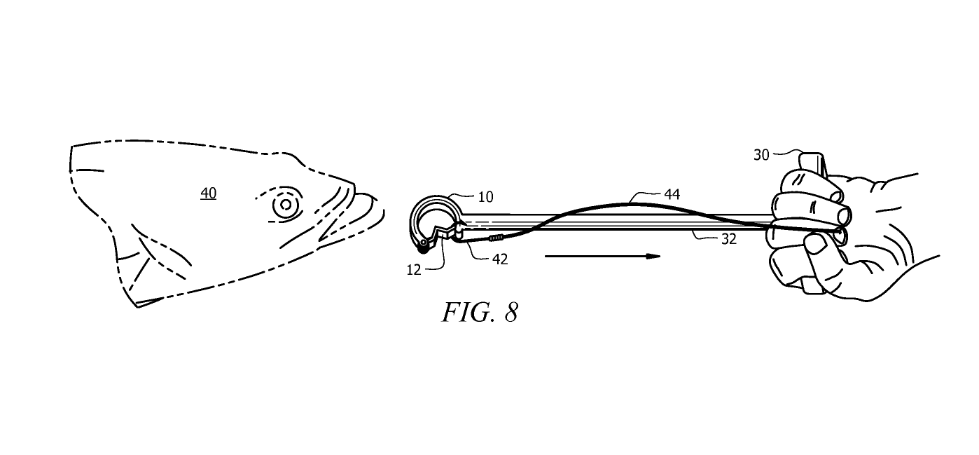

Referring to FIGS. 6-8 a first perspective view of the first embodiment of the present invention in use is shown. A fish 40 has a fishing hook 42 lodge in its mouth/throat. The operation begins with the gate/latch 12 being pushed against the fishing line 44 until the gate/latch 12 opens, at which time the fishing line 44 passes into the partial loop 10 as shown in FIG. 7. The gate/latch 12 closes after the fishing line 44 enters the partial loop 10; holding the fishing line 44 within the partial loop 10. The partial loop 10 end of the fish hook dehooker 8 is run down the fishing line 44 as shown in FIG. 7 until it reaches the fishing hook. To dehook the fish, the partial loop 10 is pushed against the flesh of the fish around where the hook is caught and the fishing line 44 is pulled, removing the fishhook 42 as in FIG. 8. In some instances, the fish dehooker is thrusted toward the fish to dislodge the hook.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A fish dehooker with a line latch, the fish dehooker comprising:
a shaft;
a handle at a first end of the shaft;
a partial loop at a distal end of the shaft, the partial loop having an open section; and
a spring-loaded gate pivotally affixed to the partial loop thereby covering the open section, whereas the spring-loaded gate opens inward within the partial loop when pressed by a fishing line and the spring-loaded gate closes holding the fishing line within the partial loop.

2. The fish dehooker with a line latch of claim 1, wherein handle and the shaft form a T-shape.

3. The fish dehooker with a line latch of claim 1, wherein the spring-loaded gate is spring-loaded with a torsion spring.

4. The fish dehooker with a line latch of claim 1, wherein the spring-loaded gate is substantially flat.

5. The fish dehooker with a line latch of claim 1, wherein the spring-loaded gate is partially flat with a detent for engaging with the fishing line.

6. A method of dehooking marine wildlife comprising:
providing a fish caught on a hook, the hook attached to a fishing line;
providing a fish dehooker comprising:
a shaft;
a handle at a first end of the shaft;
a partial loop at a distal end of the shaft, the partial loop having an open section; and
a spring-loaded gate pivotally affixed to the partial loop thereby covering the open section, whereas the spring-loaded gate opens inward within the partial loop when pressed by the fishing line and the spring-loaded gate closes holding the fishing line within the partial loop;
applying pressure to the fishing line by the spring-loaded gate, thereby opening the spring loaded gate and the fishing line entering the partial loop;
the gate closing behind the fishing line thereby capturing the fishing line within the partial loop;
holding the handle and guiding the partial loop down the fishing line to the site of the hook; and
thrusting on the handle while holding the fish by the fishing line, thereby dislodging the hook from the fish.

7. The method of claim 6, wherein handle and the shaft form a T-shape.

8. The method of claim 6, wherein the spring-loaded gate is spring-loaded with a torsion spring.

9. The method of claim 6, wherein the spring-loaded gate is substantially flat.

10. The method of claim 6, wherein the spring-loaded gate is substantially flat with a detent for engaging with the fishing line.

11. A fish dehooker with a line latch, the fish dehooker comprising:
a shaft;
a handle affixed at a first end of the shaft;
a partial loop at a distal end of the shaft, the partial loop having an open section; and
a means for sealing the partial loop, the means for sealing the partial loop pivotally affixed to the partial loop, the means for sealing the partial loop opening in an inward direction within the partial loop in response to pressure of a fishing line, and the means for sealing the partial loop closing after the fishing line is within the partial loop and the pressure of the fishing line abates.

12. The fish dehooker with a line latch of claim 11, wherein handle and the shaft form a T-shape.

13. The fish dehooker with a line latch of claim 11, wherein the means for sealing the partial loop includes a torsion spring to bias the means for sealing the partial loop closed against the partial loop.

14. The fish dehooker with a line latch of claim 11, wherein the means for sealing the partial loop is substantially flat.

15. The fish dehooker with a line latch of claim 11, wherein the means for sealing the partial loop is substantially flat with a detent for engaging with the fishing line.
